(19) United States
(12) Patent Application Publication
(10) Pub. No.: US 2025/0046102 A1
(43) Pub. Date: Feb. 6, 2025

(54) GROUND FEATURE POSITION INFORMATION OUTPUT DEVICE, ASSISTANCE CONTROL DEVICE, GROUND FEATURE POSITION INFORMATION OUTPUT METHOD, AND COMPUTER-READABLE STORAGE MEDIUM

(71) Applicant: HONDA MOTOR CO.,LTD., Tokyo (JP)

(72) Inventors: Takahiro KUREHASHI, Saitama (JP); Yuta SAKAGAWA, Saitama (JP)

(21) Appl. No.: 18/769,418

(22) Filed: Jul. 11, 2024

(30) Foreign Application Priority Data
Jul. 31, 2023 (JP) 2023-124328

(51) Int. Cl. G06V 20/56; G06V 10/40

(52) U.S. Cl. CPC G06V 20/588; G06V 10/40

(57) ABSTRACT

A ground feature position information output device includes: an image information acquisition unit which acquires a plurality of images from a plurality of viewpoints different from each other on a roadway and first information indicating respective viewpoint positions and viewing directions of the plurality of images; a ground feature position identification unit which, based on a difference in states of figures of a ground feature in each of the plurality of images and the respective viewpoint positions and viewing directions of the plurality of images identified from the first information, identifies a position of the ground feature; and a ground feature position information output unit which outputs information indicating the position of the ground feature identified by the ground feature position identification unit.

The contents of the following patent application(s) are incorporated herein by reference: NO. 2023-124328 filed in JP on Jul. 31, 2023.

### BACKGROUND

### 1. Technical Field

The present invention relates to a ground feature position information output device, an assistance control device, a ground feature position information output method, and a computer-readable storage medium.

### 2. Related Art

In recent years, efforts have been intensified to provide access to a sustainable transportation system with consideration given to even vulnerable people among other traffic participants. To realize this, research and development has been focused on to further improve traffic safety and convenience through research and development regarding a preventive safety technique. Patent documents 1-3 describe techniques for generating map information.

### PRIOR ART DOCUMENT

### Patent Document

Patent Document 1: Japanese Patent Application Publication No. 2020-24693
Patent Document 2: Japanese Patent Application Publication No. 2023-27065
Patent Document 3: Japanese Patent Application Publication No. 2013-30006

### BRIEF DESCRIPTION OF THE DRAWINGS

FIG. 1 schematically illustrates a usage scene of an assistance system 10.

FIG. 2 illustrates a functional configuration of an assistance device 60.

FIG. 3 illustrates an example of processes for identifying a position of a pedestrian bridge 50 from images provided by an environmental image server 62.

FIG. 4 illustrates another example of the processes for identifying the position of the pedestrian bridge 50 from the images provided by the environmental image server 62.

FIG. 5 illustrates another example of the processes for identifying the position of the pedestrian bridge 50 from the images provided by the environmental image server 62.

FIG. 6 illustrates an example of a flowchart for processes according to a ground feature position information output method performed in the assistance device 60.

FIG. 7 illustrates an example of an execution sequence of processes performed in user terminals 82, as well as in-vehicle processing devices 40 included in vehicles 20, an image capture device 70, and an assistance device 60.

FIG. 8 illustrates an example of a flowchart for processes according to an assistance control method performed in an assistance control device 202.

FIG. 9 illustrates an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

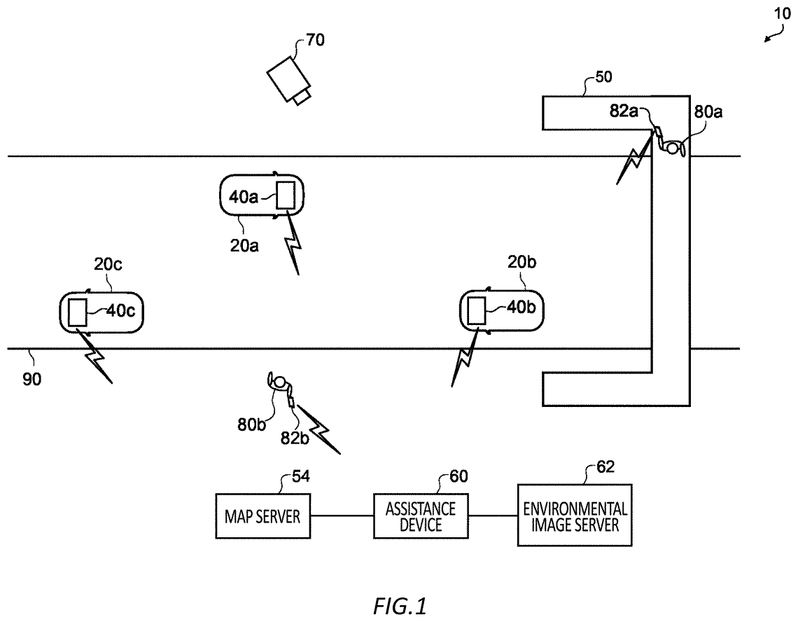

FIG. 1 schematically illustrates a usage scene of an assistance system 10. The assistance system 10 includes a vehicle 20a, a vehicle 20b, and a vehicle 20c; a user terminal 82a and a user terminal 82b; an assistance device 60; an image capture device 70; an environmental image server 62; and a map server 64.

The vehicle 20a includes an in-vehicle processing device 40a, the vehicle 20b includes an in-vehicle processing device 40b, and the vehicle 20c includes an in-vehicle processing device 40c. The user terminal 82a is a terminal carried by a user 80a, and the user terminal 82b is a terminal carried by a user 80b. In the present embodiment, the user 80a and the user 80b are pedestrians. In the present embodiment, the user 80a is walking on a pedestrian bridge 50, and the user 80b is walking on a roadway 90.

In the present embodiment, the vehicle 20a, the vehicle 20b, and the vehicle 20c may be collectively referred to as a “vehicle(s) 20”. The in-vehicle processing device 40a, the in-vehicle processing device 40b, and the in-vehicle processing device 40c may be collectively referred to as an “in-vehicle processing device(s) 40”. The user terminal 82a and the user terminal 82b may be collectively referred to as a “user terminal(s) 82”. The user 80a and the user 80b may be collectively referred to as a “user(s) 80”.

The vehicle 20 is a vehicle that drives on the roadway 90. The vehicle 20 is an example of a moving object. The in-vehicle processing device 40 is configured by including various sensors such as a position sensor including a Global Navigation Satellite System (GNSS) receiver, and a velocity sensor such as a vehicle velocity sensor. The in-vehicle processing device 40 includes a function to process information acquired by the various sensors included in the in-vehicle processing device 40 and a function to communicate with the assistance device 60. The in-vehicle processing device 40 provides an Advanced Driver-Assistance System (ADAS) function included in the vehicle 20.

The user terminal 82 is a mobile terminal such as a smartphone, for example. The user terminal 82 is an example of the moving object. The user terminal 82 periodically transmits current position information of the user terminal 82 detected by the position sensor including the GNSS receiver to the assistance device 60. For example, the user terminal 82 transmits latitude and longitude information and altitude information indicating a current position of the user terminal 82 in a three-dimensional space.

The image capture device 70 is an image capture device provided on a transportation infrastructure. The image capture device 70 acquires positions of the vehicle 20 and the user 80 that exist within an image-capturing range of the image capture device 70 by analyzing a captured image, and transmits acquired positions of the vehicle 20 and the user 80 to the assistance device 60.

The assistance device 60 receives information transmitted from the in-vehicle processing device 40, the user terminal 82, and the image capture device 70 via mobile communication. The assistance device 60 may receive the information transmitted from the in-vehicle processing device 40, the user terminal 82, and the image capture device 70 through mobile communication and a communication line such as the Internet or a dedicated line.

The environmental image server 62 provides images from a plurality of viewing directions at a plurality of viewpoints on a roadway. For example, the environmental image server 62 collects images of an environment surrounding a vehicle driving on the roadway 90 captured from the vehicle, and, based on collected images, generates the images from the plurality of viewing directions at the plurality of viewpoints on the roadway. The environmental image server 62 generates the images from the plurality of viewing directions at the plurality of viewpoints on the roadway, for example, based on three-dimensional information acquired by a fish-eye camera or the like from the vehicle driving on the roadway 90. For example, the environmental image server 62 provides an image from a direction specified by a user and having a viewpoint of a position specified by the user. The environmental image server 62 allows for constantly changing the position on the roadway specified by the user to provide such an image as if the user actually sees a scene of the image when they are moving on the roadway.

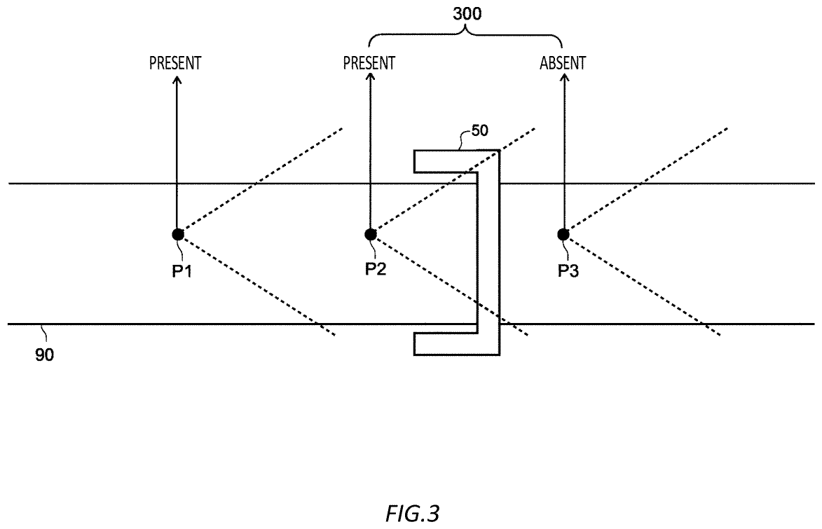

The assistance device 60, based on a plurality of images acquired from the environmental image server 62 and each having a viewpoint of a position among different positions, identifies a position where the pedestrian bridge 50 is installed. For example, the assistance device 60, based on a viewpoint on the roadway 90 corresponding to an image showing the pedestrian bridge 50 and a viewpoint on the roadway 90 corresponding to an image not showing the pedestrian bridge 50, identifies the position of the pedestrian bridge 50 in a driving direction on the roadway 90, and stores the position of the identified pedestrian bridge 50. A method for determining the position of the pedestrian bridge 50 will be described in connection to such as FIG. 3 to FIG. 5. The pedestrian bridge 50 is an example of a ground feature.

The map server 64 provides map information. The map information that the map server 64 provides includes a position of a roadway, a type of the roadway, a roadway type, and the like, but does not include information indicating a position of the pedestrian bridge 50.

The assistance device 60, based on position information of the vehicle 20 and the user 80 received from the in-vehicle processing device 40, the user terminal 82, and the image capture device 70; the position of the pedestrian bridge 50 identified from the image provided from the environmental image server 62; and the information acquired from the map server 64, provides traffic assistance for the vehicle 20. For example, the assistance device 60 determines whether the user 80 and the vehicle 20 will approach each other within a predetermined time, and, when it is determined that the user 80 and the vehicle 20 will approach each other within the predetermined time, provides the traffic assistance for the vehicle 20 and/or the user 80. The assistance device 60 provides the traffic assistance, for example, by transmitting alert information for instructing the in-vehicle processing device 40 and the user terminal 82 to output an alert.

Under the circumstance shown in FIG. 1, since the user terminal 82b is moving toward the roadway 90 in a direction intersecting a direction of travel of the vehicle 20b, the assistance device 60 determines that the user terminal 82b and the vehicle 20b will approach each other within the predetermined time, and transmits the alert information to the vehicle 20b and the user terminal 82b. On the other hand, the user terminal 82a is moving in a direction intersecting a direction of travel of the vehicle 20a, and it is expected that the vehicle 20a and the user terminal 82a will approach each other in the latitude-longitude coordinate system within the predetermined time. However, since it is determined that the user terminal 82a is in the position of the pedestrian bridge 50 and the altitude information of the user terminal 82a exceeds a predetermined height, the assistance device 60 does not transmit the alert information to the vehicle 20a and the user terminal 82a, considering them as not being subject to the traffic assistance.

According to the assistance system 10, the position where the pedestrian bridge 50 is provided can be identified in a simple way. This allows a pedestrian walking on the pedestrian bridge 50 not to be subject to the traffic assistance. This allows for refraining from providing unnecessary traffic assistance.

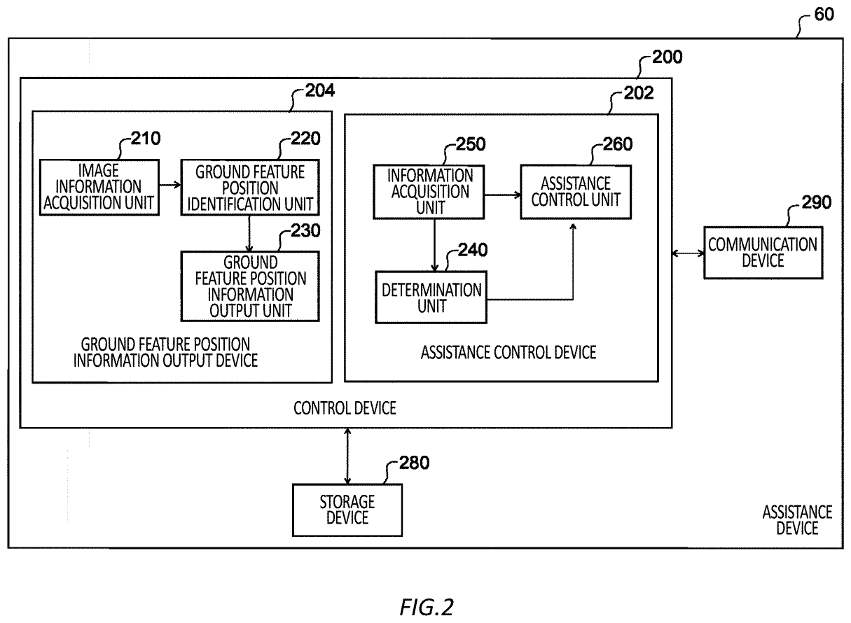

FIG. 2 illustrates a functional configuration of the assistance device 60. The assistance device 60 includes a control device 200, a communication device 290, and a storage device 280.

The communication device 290 is responsible for communication between each of the in-vehicle processing devices 40 and the user terminals 82 and the assistance device 60 based on control of the control device 200. The control device 200 is implemented by being provided with a circuit such as an operation processing unit including a processor, for example. The control device 200 may be implemented by a microcomputer provided with a CPU, a ROM, a RAM, an I/O, a bus, and the like. The storage device 280 is implemented by being provided with a non-volatile storage medium. The control device 200 performs processing using information stored in the storage device 280.

The control device 200 includes an assistance control device 202 and a ground feature position information output device 204. The ground feature position information output device 204 includes an image information acquisition unit 210, a ground feature position identification unit 220, and a ground feature position information output unit 230. The assistance control device 202 includes an information acquisition unit 250, a determination unit 240, and an assistance control unit 260. Note that, a form may be employed where the assistance device 60 does not have some of functions of the functional configuration shown in FIG. 2.

The image information acquisition unit 210 acquires a plurality of images from a plurality of viewpoints different from each other on the roadway 90 and first information indicating respective viewpoint positions and viewing directions of the plurality of images. The ground feature position identification unit 220, based on a difference in states of figures of a ground feature in each of the plurality of images and the respective viewpoint positions and viewing directions of the plurality of images identified from the first information, identifies a position of the ground feature. The ground feature position information output unit 230 outputs information indicating the position of the ground feature identified by the ground feature position identification unit 220. The information output by the ground feature position information output unit 230 may be stored in the storage device 280.

The ground feature position identification unit 220 may, based on whether the figure of the ground feature is included in each of the plurality of images, and the respective viewpoint positions and viewing directions of the plurality of images identified from the first information, identify the position of the ground feature.

When a figure of a first ground feature is included in a first image among the plurality of images and the figure of the ground feature is not included in a second image among the plurality of images, the ground feature position identification unit 220 may identify a range between a viewpoint position of the first image and a viewpoint position of the second image as the position of the ground feature. Here, the viewpoint position of the second image is different from that of the first image and the second image has a viewing direction wherein a difference between the viewing direction and a viewing direction of the first image is less than a predetermined value. The ground feature position identification unit 220 may identify the position of the ground feature from a plurality of first images having a first viewing direction among the plurality of images; and when the figure of the ground feature is included in a second image having a second viewing direction different from the first viewing direction, based on a viewpoint position of the second image and the position of the ground feature identified from the plurality of first images, correct the position of the ground feature.

The ground feature position identification unit 220 may identify a first position as the position of the ground feature from a plurality of first images having a first viewing direction among the plurality of images; identify a third position as the position of the ground feature from a plurality of third images having a third viewing direction opposite to the first viewing direction among the plurality of images; and based on the first position and the third position, identify the position of the ground feature.

In the present embodiment, the ground feature is the pedestrian bridge 50. The ground feature may be a vehicle stop line, a crosswalk, a road sign, and/or the like.

In the assistance control device 202, the information acquisition unit 250 acquires second information including position information of the user terminal 82 and position information of the vehicle 20 driving on the roadway 90. The assistance control unit 260, based on the second information and the information indicating the position of the ground feature output from the ground feature position information output unit, provides traffic assistance for the vehicle 20 driving on the roadway 90 and/or a user associated with the user terminal 82.

When the ground feature is the pedestrian bridge 50, the determination unit 240, based on the second information, determines whether the position of the user terminal 82 is in the position of the pedestrian bridge 50. The assistance control unit 260 determines whether to provide the traffic assistance considering a determination result by the determination unit 240. When it is determined by the determination unit 240 that the position of the user terminal 82 is in the position of the pedestrian bridge 50 and an altitude at which the user terminal 82 is located, identified from the position information of the user terminal 82, is equal to or more than a predetermined value, the assistance control unit 260 determines not to provide the traffic assistance.

On the other hand, when it is determined by the determination unit 240 that the position of the user terminal 82 is not in the position of the pedestrian bridge 50, or when it is determined by the determination unit 240 that the position of the user terminal 82 is in the position of the pedestrian bridge 50 and an altitude at which the user terminal 82 is located, identified from the position information of the user terminal 82, is less than a predetermined value, the assistance control unit 260 controls to provide the traffic assistance on condition that it is determined that the position of the vehicle 20 and the position of the user terminal 82 will approach each other in the latitude-longitude coordinate system.

FIG. 3 illustrates an example of processes for identifying the position of the pedestrian bridge 50 from images provided by the environmental image server 62.

Here, it is assumed that images from a viewpoint position P1, a viewpoint position P2, and a viewpoint position P3 between the viewpoint position P1 and the viewpoint position P3 are provided from the environmental image server 62 in association with respective viewpoint positions and viewing directions. That is, it is assumed that the environmental image server 62 can provide images from discrete viewpoint positions. Here, it is assumed that a viewing direction of each image is along a driving direction of a vehicle on the roadway 90.

When the image information acquisition unit 210 acquires the images from the viewpoint position P1, the viewpoint position P2, and the viewpoint position P3, the ground feature position identification unit 220 analyzes the respective images to determine whether a figure of the pedestrian bridge 50 is included in the respective images. The ground feature position identification unit 220 determines that the figure of the pedestrian bridge 50 is included in each of the images from the viewpoint position P1 and the viewpoint position P2, and determines that the figure of the pedestrian bridge 50 is not included in the image from the viewpoint position P3. The “present” associated with each viewpoint position in FIG. 3 indicates that the figure of the pedestrian bridge 50 is included in the image, and the “absent” associated with each viewpoint position indicates that the figure of the pedestrian bridge 50 is not included in the image.

When the ground feature position identification unit 220 determines that the figure of the pedestrian bridge 50 is included in the image from the viewpoint position P1 and the image from the viewpoint position P2 and that the figure of the pedestrian bridge 50 is not included in the image from the viewpoint position P3, it determines that the pedestrian bridge 50 exists between the viewpoint position P2 and the viewpoint position P3. In doing so, the ground feature position identification unit 220 determines that the pedestrian bridge 50 exists within a range 300 along the driving direction on the roadway 90. The ground feature position information output unit 230 outputs information indicating the range 300 as information indicating the position of the pedestrian bridge 50.

However, when angles of view of images provided from the environmental image server 62 are restricted, an image from a viewpoint position immediately before passing the pedestrian bridge 50 may not include the figure of the pedestrian bridge 50. Therefore, the ground feature position identification unit 220 may determine that the pedestrian bridge 50 exists within a broader range including at least the range 300, and the ground feature position information output unit 230 may output information indicating the broader range as the information indicating the position of the pedestrian bridge 50.

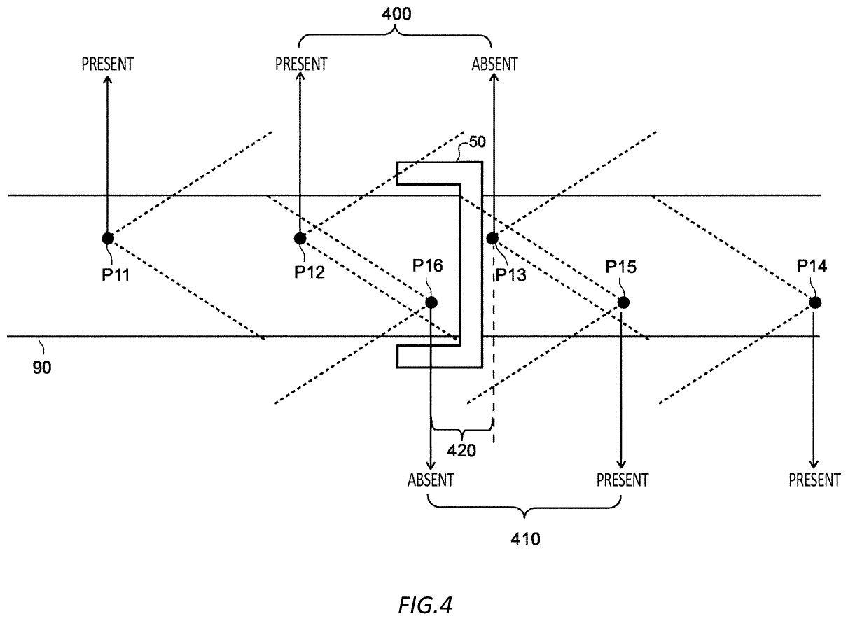

FIG. 4 illustrates another example of the processes for identifying the position of the pedestrian bridge 50 from the images provided by the environmental image server 62.

Here, it is assumed that images from a viewpoint position P11, a viewpoint position P12, and a viewpoint position P13 as well as images from a viewpoint position P14, a viewpoint position P15, and a viewpoint position P16 are provided from the environmental image server 62 in association with respective viewpoint positions and viewing directions.

Here, it is assumed that a viewing direction of each of the images from the viewpoint position P11, the viewpoint position P12, and the viewpoint position P13 is along a first direction in which a vehicle can drive on the roadway 90. On the other hand, it is assumed that a viewing direction of each of the images from the viewpoint position P14, the viewpoint position P15, and the viewpoint position P16 is along a third direction in which a vehicle can drive on the roadway 90. The third direction is an opposite direction to the first direction.

The ground feature position identification unit 220 analyzes the images from the viewpoint position P11, the viewpoint position P12, and the viewpoint position P13 to determine that the figure of the pedestrian bridge 50 is included in each of the images from the viewpoint position P11 and the viewpoint position P12, and to determine that the figure of the pedestrian bridge 50 is not included in the image from the viewpoint position P13. In doing so, the ground feature position identification unit 220 determines that the pedestrian bridge 50 exists between the viewpoint position P12 and the viewpoint position P13, and determines that the pedestrian bridge 50 exists within a range 400 along the driving direction on the roadway 90.

The ground feature position identification unit 220 analyzes the images from the viewpoint position P14, the viewpoint position P15, and the viewpoint position P16 to determine that the figure of the pedestrian bridge 50 is included in each of the images from the viewpoint position P14 and the viewpoint position P15, and to determine that the figure of the pedestrian bridge 50 is not included in the image from the viewpoint position P16. In doing so, the ground feature position identification unit 220 determines that the pedestrian bridge 50 exists between the viewpoint position P15 and the viewpoint position P16.

The ground feature position identification unit 220 determines that the pedestrian bridge 50 exists in a range 420 where the range 400 and the range 410 overlap. The ground feature position information output unit 230 outputs information indicating the range 420 as the information indicating the position of the pedestrian bridge 50.

As described above, when angles of view of images provided from the environmental image server 62 are restricted, an image from a viewpoint position immediately before passing the pedestrian bridge 50 may not include the figure of the pedestrian bridge 50. Therefore, the ground feature position identification unit 220 may determine that the pedestrian bridge 50 exists within a first broader range including at least the range 400 and the pedestrian bridge 50 exists within a second broader range including at least the range 410, and may thus determine that the pedestrian bridge 50 exists within a range where the first range and the second range overlap. In this case, the ground feature position information output unit 230 may output information indicating the range where the first range and the second range overlap as the information indicating the position of the pedestrian bridge 50.

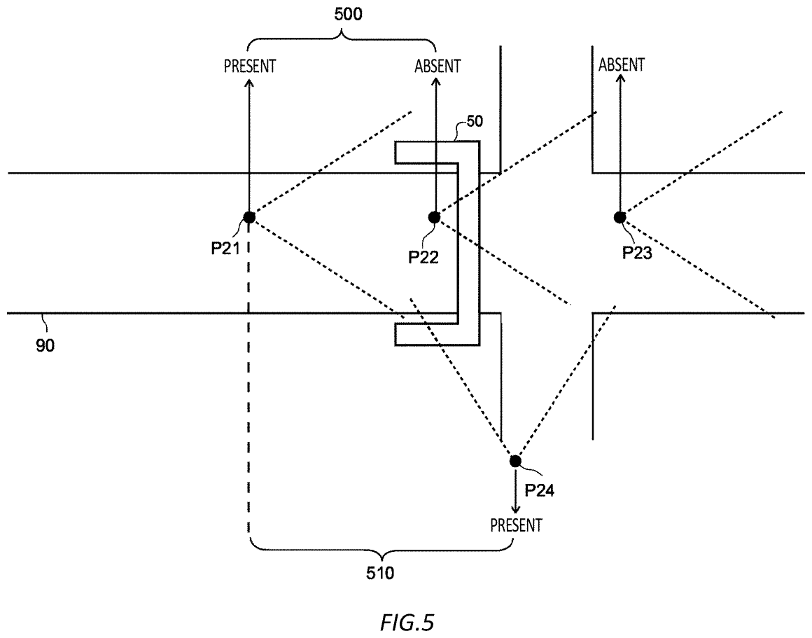

FIG. 5 illustrates another example of the processes for identifying the position of the pedestrian bridge 50 from the images provided by the environmental image server 62.

Here, it is assumed that images from a viewpoint position P21, a viewpoint position P22, and a viewpoint position P23 as well as an image from a viewpoint position P24 are provided from the environmental image server 62 in association with respective viewpoint positions and viewing directions.

Here, it is assumed that a viewing direction of each of the images from the viewpoint position P21, the viewpoint position P22, and the viewpoint position P23 is along a first direction in which a vehicle can drive on the roadway 90. On the other hand, a viewing direction of the image from the viewpoint position P24 is along a second direction intersecting the first direction on the roadway 90. As an example, the second direction is orthogonal to the first direction.

The ground feature position identification unit 220 analyzes the images from the viewpoint position P21, the viewpoint position P22, and the viewpoint position P23 to determine that the figure of the pedestrian bridge 50 is included in the image from the viewpoint position P21, and to determine that the figure of the pedestrian bridge 50 is not included in the images from the viewpoint position P22 and the viewpoint position P23. In doing so, the ground feature position identification unit 220 determines that the pedestrian bridge 50 exists between the viewpoint position P21 and the viewpoint position P22, and determines that the pedestrian bridge 50 exists within a range 500 along the driving direction on the roadway 90. In this manner, when angles of view of images provided from the environmental image server 62 are restricted, an image from a viewpoint position immediately before passing the pedestrian bridge 50 such as the viewpoint position P22 may not include the figure of the pedestrian bridge 50.

Here, the ground feature position identification unit 220 analyzes the image from the viewpoint position P24 to determine that the figure of the pedestrian bridge 50 is included in the image from the viewpoint position P24. In this case, it can be determined that the pedestrian bridge 50 exists somewhere in a direction along the viewing direction of the viewpoint position P24. Particularly in the example shown in FIG. 5, it is determined that the figure of the pedestrian bridge 50 is included in the image from the viewpoint position P24 on the side closer to the viewpoint position P22 than the center of the image. Therefore, the ground feature position identification unit 220 determines that the pedestrian bridge 50 exists in a range 510 between P21 and P24 in a direction in which P21 and P22 are connected.

The ground feature position information output unit 230 outputs information indicating the range 510 as the information indicating the position of the pedestrian bridge 50.

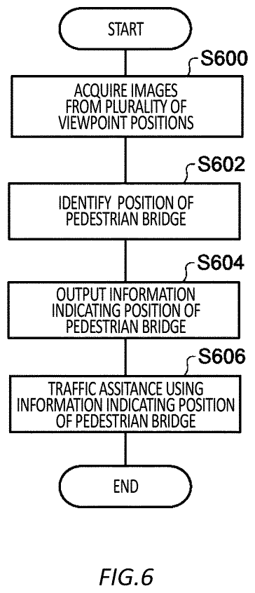

FIG. 6 illustrates an example of a flowchart for processes according to a ground feature position information output method performed in the assistance device 60. The processes of the present flowchart may be performed repeatedly at a predetermined time interval.

In S600, the image information acquisition unit 210 acquires images from a plurality of viewpoint positions from the environmental image server 62. Respective viewpoint positions and viewing directions are associated with the images acquired from the environmental image server 62.

In S602, the ground feature position identification unit 220, based on the figures of the pedestrian bridge 50 in the plurality of images and viewpoint positions and viewing directions associated with respective images, identifies a position of the pedestrian bridge 50. For example, the ground feature position identification unit 220 identifies a range where the pedestrian bridge 50 is located by means of the approaches described in connection to such as FIG. 3 to FIG. 5.

In S604, the ground feature position information output unit 230 outputs information indicating the position of the pedestrian bridge 50 identified in S602. For example, the ground feature position information output unit 230 stores information indicating the range where the pedestrian bridge 50 exists identified in S602 in the storage device 280.

In S606, the assistance control device 202, based on the information indicating the position of the pedestrian bridge 50 output by the ground feature position information output unit 230, controls for traffic assistance.

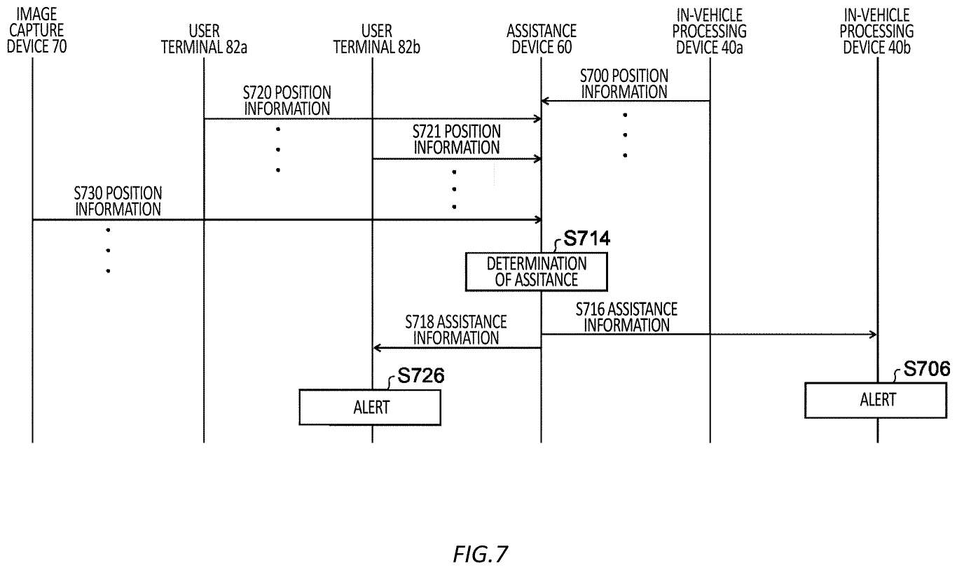

FIG. 7 illustrates an example of an execution sequence of processes performed in the user terminals 82, as well as the in-vehicle processing devices 40 included in the vehicles 20, the image capture device 70, and the assistance device 60.

In S700, the in-vehicle processing device 40a transmits position information of the vehicle 20 to the assistance device 60. The position information is periodically transmitted from the in-vehicle processing device 40a to the assistance device 60.

In S720, the user terminal 82a transmits, to the assistance device 60, position information indicating a current position of the user terminal 82a based on a signal received from a GNSS satellite. The position information is periodically transmitted from the user terminal 82a to the assistance device 60.

In S721, the user terminal 82b transmits, to the assistance device 60, position information indicating a current position of the user terminal 82b based on a signal received from the GNSS satellite. The position information is periodically transmitted from the user terminal 82b to the assistance device 60.

In S730, the image capture device 70 transmits, to the assistance device 60, position information indicating the positions of the users 80 and the positions of the vehicles 20 obtained by analyzing images captured by the image capture device 70. The position information is periodically transmitted from the image capture device 70 to the assistance device 60.

In S714, the assistance control unit 260 of the assistance device 60, based on the position information about the vehicles 20 acquired from the in-vehicle processing devices 40, the position information about the user terminals 82 acquired from the user terminals 82, the position information about the vehicles 20 and the user terminals 82 acquired from the image capture device 70, the information indicating the position of the pedestrian bridge 50 output by the ground feature position information output device 204, and the map information provided from the map server 64, determines whether to provide the traffic assistance for the vehicles 20 and the user terminals 82.

Specifically, the assistance control unit 260, based on the position information about the vehicles 20, the position information about the user terminals 82, and the map information acquired from the map server 64, determines whether the vehicles 20 and the user terminals 82 will approach each other within a predetermined distance within a predetermined time. When the assistance control unit 260 determines that the vehicles 20 and the user terminals 82 will approach each other within the predetermined distance within the predetermine time, it determines to provide the traffic assistance.

In the present embodiment, it is determined by the assistance control unit 260 that the vehicle 20b and the user terminal 82b will approach each other within the predetermined distance within the predetermined time. On the other hand, for the user terminal 82a, although it can be determined that the user terminal 82a and the vehicle 20a will approach each other within the predetermined distance within the predetermined time, it is determined that the position of the user terminal 82a in the latitude-longitude coordinate system is within a range where the pedestrian bridge 50 exists and the altitude of the user terminal 82a is higher than a predetermined threshold considering from the position information about the user terminal 82a and the information indicating the position of the pedestrian bridge 50. Thus, the user terminal 82a is excluded as a target of the process for the traffic assistance by the assistance control device 202.

In doing so, in S716, the assistance control unit 260 controls the communication device 290 to transmit, to the in-vehicle processing device 40b, assistance information for instructing the in-vehicle processing device 40b to output an alert. Furthermore, in S718, the assistance control unit 260 controls the communication device 290 to transmit, to the user terminal 82b, assistance information for instructing the user terminal 82b to output an alert.

In doing so, when the user terminal 82b receives the assistance information from the assistance device 60, then in S726, it notifies the user 80b of an indication that there is a vehicle 20 approaching the user 80b by means of a Human Machine Interface (HMI) function included in the user terminal 82b. The user terminal 82b may notify the user 80b of the indication that there is a vehicle approaching the user 80b by means of voice.

When the in-vehicle processing device 40b receives the assistance information from the assistance device 60, then in S706, it notifies an occupant of the vehicle 20b of an indication that there is a user approaching the vehicle 20b by means of a HMI function included in the in-vehicle processing device 40b. The in-vehicle processing device 40b may notify the occupant of the vehicle 20b of an indication that there is a vehicle approaching the vehicle 20b by means of voice and by displaying on a display device included in the vehicle 20b.

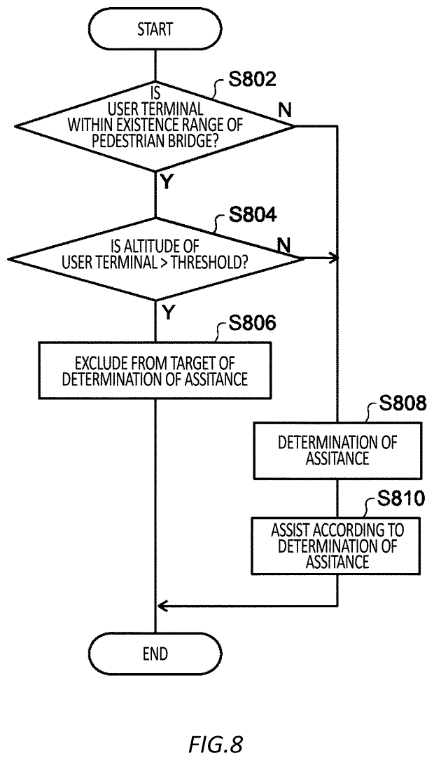

FIG. 8 illustrates an example of a flowchart for processes according to an assistance control method performed in the assistance control device 202. Some processes of the present flowchart may be performed in S714 of FIG. 7. The processes of the present flowchart may be performed repeatedly. The processes of the present flowchart may be performed for each of the user terminals 82.

In S802, the assistance control unit 260 determines whether a user terminal 82 is located within a range where the pedestrian bridge 50 exists. The assistance control unit 260, based on the position information of the user terminal 82 and information indicating the position of the pedestrian bridge 50 output by the ground feature position information output device 204, determines whether the user terminal 82 is located within the range where the pedestrian bridge 50 exists. When it is determined that the user terminal 82 is not located within the range where the pedestrian bridge 50 exists, the flow proceeds to a process of S808.

When it is determined that the user terminal 82 is located within the range where the pedestrian bridge 50 exists, then in S804, the assistance control unit 260 determines whether an altitude of the user terminal 82 is higher than a predetermined threshold. When the altitude of the user terminal 82 is equal to or less than the predetermined threshold, the flow proceeds to a process of S808.

When it is determined that the altitude of the user terminal 82 is higher than the predetermined threshold, then in S806, the user terminal 82 is excluded from the target of determination of the assistance, the processes of the present flowchart end.

In S808, the assistance control unit 260, based on the position of the user terminal 82, the position of the vehicle 20, and the map information acquired from the map server 64, determines whether the vehicle 20 and the user terminal 82 will approach each other within the predetermined distance within the predetermined time, and when it determines to provide the traffic assistance for the vehicle 20 and the user terminal 82, then in S810, it controls for the traffic assistance.

The case has been described above in which the ground feature whose position is to be identified in the ground feature position information output device 204 is the pedestrian bridge 50. However, the ground feature is not limited to the pedestrian bridge 50. A vehicle stop line, a crosswalk, a road sign, a railway track, any other construction, or the like can be applied as the ground feature. In the present embodiment, although the form has been described in which the position of the ground feature is identified based on the images acquired from the environmental image server 62, images used to identify the position of the ground feature are not limited to the images captured for the environmental image server 62. For example, the images used to identify the position of the ground feature may be images captured by a camera for the ADAS included in the vehicle 20, or may be images captured by a drive recorder installed in the vehicle 20.

According to the assistance system 10 described above, the position where a ground feature such as the pedestrian bridge 50 is provided can be identified in a simple way. This allows for refraining from providing unnecessary traffic assistance, because, for example, a pedestrian walking on the pedestrian bridge 50 can be considered as not being subject to the traffic assistance. In addition, when another ground feature is newly installed, position information of the newly installed ground feature may be acquired to be utilized in the traffic assistance before the position information of the newly installed ground feature is reflected in map information provided from the map server 64.

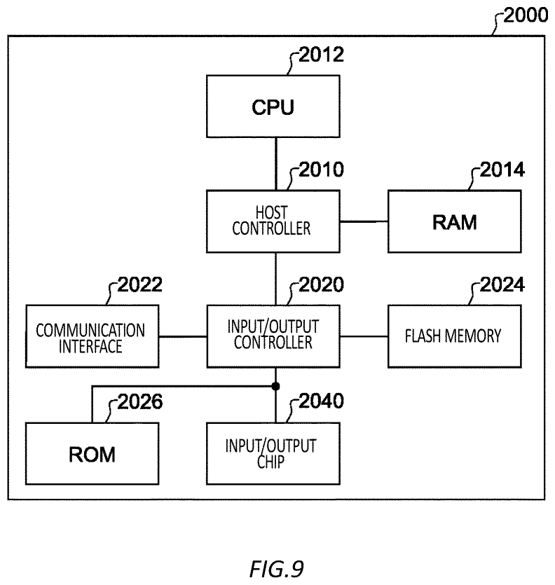

FIG. 9 illustrates an example of a computer 2000 where a plurality of embodiments of the present invention may be entirely or partially embodied. A program installed into the computer 2000 can cause the computer 2000 to function as a device such as the assistance device 60 or each unit of the device according to an embodiment; to perform an operation associated with the device or each unit of the device; and/or to perform a process or a stage of the process according to an embodiment. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. A device or a method may be configured by implementing operations or processing of information depending on a use of the computer 2000.

For example, when a communication is performed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

Programs that are installed into the computer 2000 and that cause the computer 2000 to function as the assistance device 60 may act on the CPU 2012 or the like and cause the computer 2000 to function as each unit of the assistance device 60 (e.g., the assistance control device 202, the ground feature position information output device 204, and the like) respectively. Information processing written in these program functions as each unit of the assistance device 60, which is a specific means obtained by cooperating software and various hardware resources described above, by being read into the computer 2000. These specific means implement operations or processing of information according to the intended use of the computer 2000 in the present embodiment, and the assistance device 60 is thereby constructed to be specific for the intended use.

Various embodiments have been described with reference to the block diagrams and the like. In the block diagrams, each block may represent (1) a stage of a process in which an operation is executed, or (2) each unit of the device having a role in executing the operation. Certain stages and units may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

Each process of the operations, procedures, steps, and stages etc. of performed by a device, system, program, and method shown in the claims, specification, or drawings can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: assistance system;
20: vehicle;
40: in-vehicle processing device;
50: pedestrian bridge;
60: assistance device
62: environmental image server;
64: map server;
70: image capture device;
80: user:
82: user terminal;
90: roadway;
200: control device;
202: assistance control device;
204: ground feature position information output device;
210: image information acquisition unit;
220: ground feature position identification unit;
230: ground feature position information output unit;
240: determination unit;
250: information acquisition unit;
260: assistance control unit;
280: storage device;
290: communication device;
300: range;
400, 410, 420, 500, 510: range;
2000: computer;
2010: host controller;
2012: CPU;
2014: RAM;
2020: input/output controller;
2022: communication interface;
2024: flash memory;
2026: ROM;
2040: input/output chip.

What is claimed is:

1. A ground feature position information output device comprising:
an image information acquisition unit which acquires a plurality of images from a plurality of viewpoints different from each other on a roadway and first information indicating respective viewpoint positions and viewing directions of the plurality of images;
a ground feature position identification unit which, based on a difference in states of figures of a ground feature in each of the plurality of images and the respective viewpoint positions and viewing directions of the plurality of images identified from the first information, identifies a position of the ground feature; and
a ground feature position information output unit which outputs information indicating the position of the ground feature identified by the ground feature position identification unit.

2. The ground feature position information output device according to claim 1, wherein
the ground feature position identification unit, based on whether the figure of the ground feature is included in each of the plurality of images, and the respective viewpoint positions and viewing directions of the plurality of images identified from the first information, identifies the position of the ground feature.

3. The ground feature position information output device according to claim 1, wherein
when a figure of a first ground feature is included in a first image among the plurality of images and the figure of the ground feature is not included in a second image among the plurality of images, the ground feature position identification unit identifies a range between a viewpoint position of the first image and a viewpoint position of the second image as the position of the ground feature, and
the viewpoint position of the second image is different from that of the first image and the second image has a viewing direction wherein a difference between the viewing direction and a viewing direction of the first image is less than a predetermined value.

4. The ground feature position information output device according to claim 1, wherein
the ground feature position identification unit:
identifies the position of the ground feature from a plurality of first images having a first viewing direction among the plurality of images; and
when the figure of the ground feature is included in a second image having a second viewing direction different from the first viewing direction, based on a viewpoint position of the second image and the position of the ground feature identified from the plurality of first images, corrects the position of the ground feature.

5. The ground feature position information output device according to claim 1, wherein
the ground feature position identification unit:
identifies a first position as the position of the ground feature from a plurality of first images having a first viewing direction among the plurality of images;
identifies a third position as the position of the ground feature from a plurality of third images having a third viewing direction opposite to the first viewing direction among the plurality of images; and
based on the first position and the third position, identifies the position of the ground feature.

6. The ground feature position information output device according to claim 1, wherein
the ground feature comprises a pedestrian bridge, a vehicle stop line, a crosswalk, and/or a road sign.

7. The ground feature position information output device according to claim 2, wherein
when a figure of a first ground feature is included in a first image among the plurality of images and the figure of the ground feature is not included in a second image among the plurality of images, the ground feature position identification unit identifies a range between a viewpoint position of the first image and a viewpoint position of the second image as the position of the ground feature, and
the viewpoint position of the second image is different from that of the first image and the second image has a viewing direction wherein a difference between the viewpoint direction and a viewing direction of the first image is less than a predetermined value.

8. The ground feature position information output device according to claim 2, wherein
the ground feature position identification unit:
identifies the position of the ground feature from a plurality of first images having a first viewing direction among the plurality of images; and
when the figure of the ground feature is included in a second image having a second viewing direction different from the first viewing direction, based on a viewpoint position of the second image and the position of the ground feature identified from the plurality of first images, corrects the position of the ground feature.

9. The ground feature position information output device according to claim 2, wherein
the ground feature position identification unit:
identifies a first position as the position of the ground feature from a plurality of first images having a first viewing direction among the plurality of images;
identifies a third position as the position of the ground feature from a plurality of third images having a third viewing direction opposite to the first viewing direction among the plurality of images; and
based on the first position and the third position, identifies the position of the ground feature.

10. The ground feature position information output device according to claim 4, wherein
the ground feature position identification unit:
identifies a first position as the position of the ground feature from a plurality of first images having a first viewing direction among the plurality of images;
identifies a third position as the position of the ground feature from a plurality of third images having a third viewing direction opposite to the first viewing direction among the plurality of images; and
based on the first position and the third position, identifies the position of the ground feature.

11. The ground feature position information output device according to claim 8, wherein
the ground feature position identification unit:
identifies a first position as the position of the ground feature from a plurality of first images having a first viewing direction among the plurality of images;
identifies a third position as the position of the ground feature from a plurality of third images having a third viewing direction opposite to the first viewing direction among the plurality of images; and
based on the first position and the third position, identifies the position of the ground feature.

12. The ground feature position information output device according to claim 2, wherein
the ground feature comprises a pedestrian bridge, a vehicle stop line, a crosswalk, and/or a road sign.

13. The ground feature position information output device according to claim 3, wherein
the ground feature comprises a pedestrian bridge, a vehicle stop line, a crosswalk, and/or a road sign.

14. An assistance control device comprising:
the ground feature position information output device according to claim 1;
an information acquisition unit which acquires second information including position information of a user terminal and position information of a vehicle driving on the roadway; and
an assistance control unit which, based on the second information and the information indicating the position of the ground feature output from the ground feature position information output unit, provides traffic assistance for the vehicle driving the roadway and/or a user associated with the user terminal.

15. The assistance control device according to claim 14, wherein
the ground feature is a pedestrian bridge;
the assistance control device further comprises a determination unit which, based on the second information, determines whether the position of the user terminal is in a position of the pedestrian bridge; and
the assistance control unit determines whether to provide the traffic assistance considering a determination result by the determination unit.

16. The assistance control device according to claim 15, wherein
when it is determined by the determination unit that the position of the user terminal is in the position of the pedestrian bridge and an altitude at which the user terminal is located, identified from the position information of the user terminal, is equal to or more than a predetermined value, the assistance control unit determines not to provide the traffic assistance.

17. The assistance control device according to claim 15, wherein
when it is determined by the determination unit that the position of the user terminal is not in the position of the pedestrian bridge, or when it is determined by the determination unit that the position of the user terminal is in the position of the pedestrian bridge and an altitude at which the user terminal is located, identified from the position information of the user terminal, is less than a predetermined value, the assistance control unit controls to provide the traffic assistance on condition that it is determined that the position of the vehicle and the position of the user terminal will approach each other in the latitude-longitude coordinate system.

18. The assistance control device according to claim 16, wherein
when it is determined by the determination unit that the position of the user terminal is not in the position of the pedestrian bridge, or when it is determined by the determination unit that the position of the user terminal is in the position of the pedestrian bridge and an altitude at which the user terminal is located, identified from the position information of the user terminal, is less than a predetermined value, the assistance control unit controls to provide the traffic assistance on condition that it is determined that the position of the vehicle and the position of the user terminal will approach each other in the latitude-longitude coordinate system.

19. A ground feature position information output method comprising:
acquiring a plurality of images from a plurality of viewpoints different from each other on a roadway and first information indicating respective viewpoint positions and viewing directions of the plurality of images;
based on a difference in states of figures of a ground feature in each of the plurality of images and the respective viewpoint positions and viewing directions of the plurality of images identified from the first information, identifying a position of the ground feature; and
outputting information indicating the position of the ground feature.

20. A non-transitory computer-readable storage medium having stored therein a program, the program causes a computer to function as:
an image information acquisition unit which acquires a plurality of images from a plurality of viewpoints different from each other on a roadway and first information indicating respective viewpoint positions and viewing directions of the plurality of images;
a ground feature position identification unit which, based on a difference in states of figures of a ground feature in each of the plurality of images and the respective viewpoint positions and viewing directions of the plurality of images identified from the first information, identifies a position of the ground feature; and
a ground feature position information output unit which outputs information indicating the position of the ground feature identified by the ground feature position identification unit.
